(19) United States
(12) Patent Application Publication
(10) Pub. No.: US 2024/0160938 A1
(43) Pub. Date: May 16, 2024

(54) DOMAIN GENERALIZATION BY GSNR OF PARAMETERS

(71) Applicant: NEC Laboratories America, Inc., Princeton, NJ (US)

(72) Inventors: Masoud Faraki, San Francisco, CA (US); Xiang Yu, Mountain View, CA (US); Mateusz Michalkiewicz, San Jose, CA (US)

(21) Appl. No.: 18/502,488

(22) Filed: Nov. 6, 2023

Related U.S. Application Data
(60) Provisional application No. 63/422,743, filed on Nov. 4, 2022.
(60) Provisional application No. 63/423,949, filed on Nov. 9, 2022.

(51) Int. Cl. G06N 3/084

(52) U.S. Cl. CPC G06N 3/084

(57) ABSTRACT

Methods and systems of training a model include determining a dropout mask based on gradient signal to noise ratio of parameters of a neural network model. The neural network model is trained with parameters zeroed-out according to the dropout mask. The dropout mask is iteratively updated and the training is performed iteratively based on the updated dropout mask.

### RELATED APPLICATION INFORMATION

This application claims priority to U.S. Patent Application No. 63/422,743, filed on Nov. 4, 2022, and to U.S. Patent Application No. 63/423,949, filed on Nov. 9, 2022, incorporated herein by reference in its entirety.

BACKGROUND

### Technical Field

The present invention relates to machine learning and, more generally, to domain generalization in machine learning models.

### Description of the Related Art

The training of a machine learning model makes use of a training dataset that may include data belonging to a particular domain. While an extensive training dataset may include multiple different domains, the ultimate data that is used as input during operation may belong to a domain that is distinct from the domains available during training.

### SUMMARY

A method of training a model includes determining a dropout mask based on gradient signal to noise ratio of parameters of a neural network model. The neural network model is trained with parameters zeroed-out according to the dropout mask. The dropout mask is iteratively updated and the training is performed iteratively based on the updated dropout mask.

A system for training a model includes a hardware processor and a memory that stores a computer program. When executed by the hardware processor, the computer program causes the hardware processor to determine a dropout mask based on gradient signal to noise ratio of parameters of a neural network model, to train the neural network model with parameters zeroed-out according to the dropout mask, and to iteratively update the dropout mask and performing the training based on the updated dropout mask.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram of an exemplary video monitoring embodiment where a domain in use may differ from a domain of video monitoring training data, in accordance with an embodiment of the present invention;

FIG. 2 is pseudo-code of a method of performing drop-out during training of a model, in accordance with an embodiment of the present invention;

FIG. 3 is pseudo-code of a method for performing meta-training to determine dropout masking parameters during training of a model, in accordance with an embodiment of the present invention;

FIG. 4 is a block/flow diagram of a method for training a neural network model that generalizes well to new domains, in accordance with an embodiment of the present invention;

FIG. 5 is a block/flow diagram of a method for determining a dropout mask, in accordance with an embodiment of the present invention;

FIG. 6 is a block/flow diagram of a method for training and using a model with cross-domain generalizability, in accordance with an embodiment of the present invention;

FIG. 7 is block diagram of a computing device that can train and use a model with cross-domain generalizability, in accordance with an embodiment of the present invention;

FIG. 8 is a diagram of a neural network architecture that can be used to implement part of a model with cross-domain generalizability, in accordance with an embodiment of the present invention; and

FIG. 9 is a diagram of a deep neural network architecture that can be used to implement part of a model with cross-domain generalizability, in accordance with an embodiment of the present invention.

### DETAILED DESCRIPTION OF PREFERRED EMBODIMENTS

Domain generalization is the task of learning a feature representation that is robust to distribution shifts. A training dataset may have training samples that are captured in multiple different conditions, but the data received during operation of the trained model may belong to a domain that was not available during training. The test distribution may therefore be unknown, while the learning mechanism may make use of training domain statistics to attempt to handle test-time scenarios.

Models with a high gradient signal to noise ratio (GSNR), which is the ratio of squared mean over variance of parameter gradients on a particular data distribution, exhibit a smaller gap between their performance when operating on a domain available during training and a previously unseen domain. Additionally, different parts of a neural network model favor different dropout ratios. The dropout probability for each neural network block may therefore be learned.

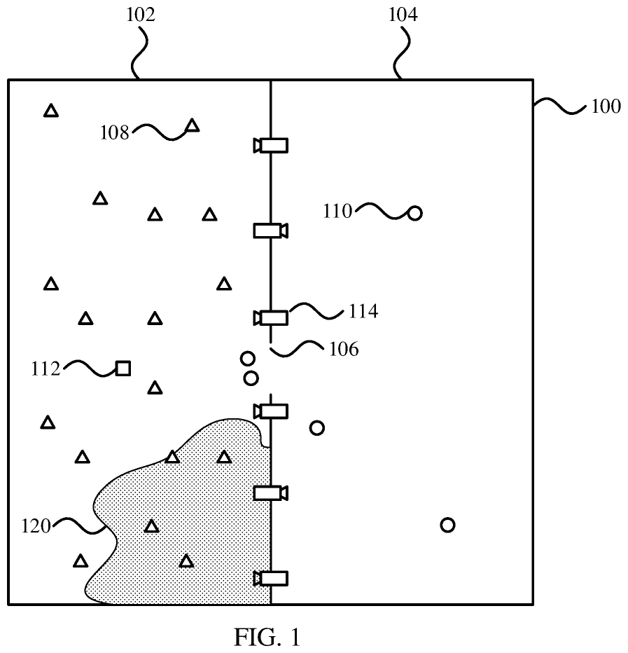

Referring now in detail to the figures in which like numerals represent the same or similar elements and initially to FIG. 1, an environment 100 is shown. For example, one type of environment that is contemplated is a mall or shopping center, which may include a common space 102 and one or more regions 104, such as a store. The common space 102 may be an outside area or may be an enclosed space, such as a shopping mall. It should be understood that this example is provided solely for the purpose of illustration, and should not be regarded as limiting.

A boundary is shown between the common space 102 and the region 104. The boundary can be any appropriate physical or virtual boundary. Examples of physical boundaries include walls and rope—anything that establishes a physical barrier to passage from one region to the other. Examples of virtual boundaries include a painted line and a designation within a map of the environment 100. Virtual boundaries do not establish a physical barrier to movement, but can nonetheless be used to identify regions within the environment. For example, a region of interest may be established next to an exhibit or display, and can be used to indicate people's interest in that display. A gate 106 is shown as a passageway through the boundary, where individuals are permitted to pass between the common space 102 and the region 104.

The environment 100 is monitored by a number of video cameras 114. Although this embodiment shows the cameras 114 being positioned at the gate 106, it should be understood that such cameras can be positioned anywhere within the common space 102 and the region 104. The video cameras 114 capture live streaming video of the individuals in the environment. A number of individuals are shown, including untracked individuals 108, shown as triangles, and tracked individuals 110, shown as circles. Also shown is a tracked person of interest 112, shown as a square. In some examples, all of the individuals may be tracked individuals. In some examples, the tracked person of interest 112 may be tracked to provide an interactive experience, with their motion through the environment 100 being used to trigger responses.

The environment 100 may include different environmental conditions. For example, a region 120 may include haze or dust that affects the video captured by a camera 114. Some areas may have better or worse lighting, or may be more affected by external light levels during the day. For example, the common space 102 may have an abundance of natural lighting that changes with over the course of a day, while the region 104 may be artificially lit.

The different environments may represent different domains. Thus an object detection or facial recognition model that is trained on interior scenes may perform better in the region 104 and may have diminished performance in the common space 102 where lighting and air quality conditions may vary.

The terms x and y may denote images and their corresponding labels, sampled from a data distribution [symbol] . The function f₇₄ (x, M) represents a neural network model, such as a residual neural network (ResNet) that is parameterized by θ, where a tensor M is applied to each activation block.

The GSNR may be used to characterize the generalization gap between domains. Given a neural network f, loss function [symbol] , images x, and their corresponding labels y, the GSNR of a parameter θ is defined as the ratio between parameters' mean gradients with respect to the loss function and the corresponding variance:

$$r ( θ ) = \frac{{\tilde{g}}^{2} ( θ )}{{ρ}^{2} ( θ )}$$

$$where \tilde{g} ( θ ) = {E}_{( x , y ) \sim Z} ( \frac{\partial ℒ ( f ( x , θ ) , y )}{\partial θ} )$$

$${ρ}^{2} ( θ ) = {Var}_{( x , y ) - Z} ( \frac{\partial ℒ ( f ( x , θ ) , y )}{\partial θ} )$$

Given an empirical training loss on dataset D and an empirical testing loss on

dataset D′:

$$L [ D ] = \frac{1}{n} {\sum }_{i = 1}^{n} ℒ ( f ( {x}_{i} , θ ) , y )$$

$$L [ {D}^{′} ] = \frac{1}{n} {\sum }_{i = 1}^{n} ℒ ( f ( {x}_{i}^{′} , θ ) , {y}^{′} )$$

where n is the number of images in the respective dataset, xᵢ and x′ᵢ are images from the respective datasets, and y and y′ are the labels of the respective images. When GSNR is 1, then the performance gap between the training dataset and the testing dataset is 0, which implies perfect generalization.

A quantitative relationship may be developed between a parameter's GSNR and the ability of the model to generalize well to examples from previously unseen domains. As the ratio between mean and variance of the gradients cannot be readily optimized for, a model's GSNR may be enhanced by iteratively zeroing parameters exhibiting high GSNRs.

While simply muting random parameters during training is not an effective strategy for domain generalization, selectively muting the most significant features can improve cross-domain generalization. The importance of the most predictive features can be measured by the magnitude of the gradients, focusing on the parameters with high GSNR. The optimal dropout ratio varies across different ResNet blocks and across different domains. While a trivial solution would be to find the ratios naively through a parameter grid search, this approach can be infeasible as the number of possible configurations grows exponentially with the depth of the network. The present models may use meta-learning, where a parameter modulating the amount of activation to be muted is learned in meta-learning.

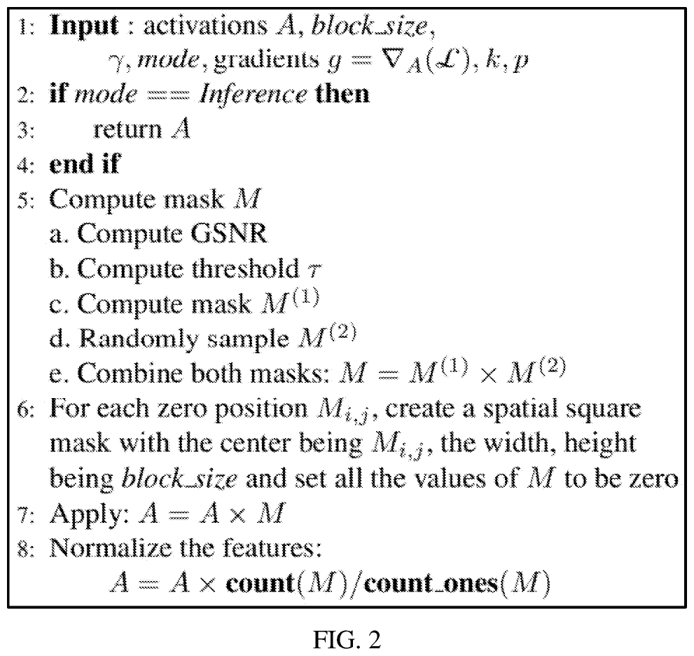

Referring now to FIG. 2, pseudo-code for a drop function is shown that is sensitive to GSRN. A dropout mask is generated at each training step to mute a subset of the activations of a ResNet. A forward pass first calculates the gradients of the loss function with respect to the parameters of the i^{th} ResNet block:

$${g}_{i}^{( 1 )} = \frac{\partial ℒ ( {f}_{θ} ( x , 1 ) , y )}{\partial {θ}_{b l o c {k}_{i}}}$$

At this stage, an identity tensor 1 is used to compute logits. The GSRN is calculated for each parameter θⱼ:

$${r}_{j} = \frac{{E}_{( x , y ) \sim Z} ( g ( x , y , {θ}_{j} ) )}{{Var}_{( x , y ) \sim Z} ( g ( x , y , {θ}_{j} ) )}$$

Here the mean and variance of the data distribution [symbol] is approximated by the mean and variance within a current batch. A binary mask may be constructed where parameters with the largest GSNR values are zeroed:

$${m}_{j}^{( 1 )} = \{ \begin{matrix}1 , & if {r}_{j} \geq τ \\ 0 , & otherwise\end{matrix}$$

with the threshold τ being the k^{th} largest GSRN value in the ResNet block i:

$${τ}_{i} = {top}_{j} k ( {r}_{j} , k )$$

where k is a parameter that determines how many parameters will be dropped out. A mask identifying whether muting should occur is determined as:

mⱼ⁽²⁾˜Bernoulli(ρ)

The masks may be combined to select which activations should be set to zero:

M=M⁽¹⁾×M⁽²⁾

where M⁽¹⁾ and M⁽²⁾ are full masks formed from mⱼ⁽¹⁾ and mⱼ⁽²⁾ across the parameters θⱼ. The gradients of the loss function may then be computed with respect to all of the parameters:

$$g = \frac{\partial ℒ ( {f}_{θ} ( x , M ) , y )}{\partial θ}$$

The gradients may then be optimized. This procedure manually selects the dropout ratio, which can be challenging as different ResNet blocks and domains favor different dropout ratios.

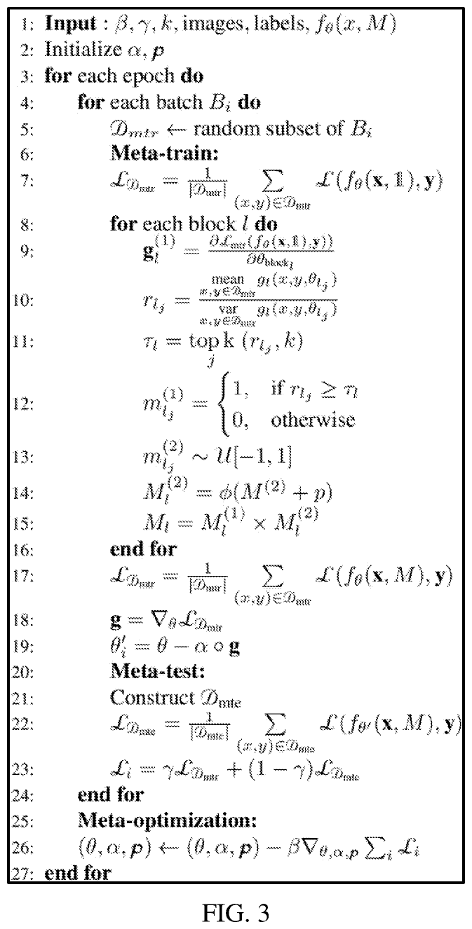

Referring now to FIG. 3, pseudo-code for meta-learning of the GSRN parameters is shown. In this approach, the second mask M⁽²⁾ may be sampled from a uniform distribution and a scaled hard sigmoid function ϕ may be applied:

mⱼ⁽²⁾=˜μ[−1, 1]

M⁽²⁾=ϕ(MM⁽²⁾=P)

where ϕis defined as:

$$ϕ ( x ) = \{ \begin{matrix}0 , & if x \leq - 3 \\ 1 , & if x \geq 3 \\ \frac{x}{6} + \frac{1}{2} , & otherwise\end{matrix}$$

where the parameter p modulates the amount of activations to be zeroed. Thus, p describes the dropout ratio and does not pose any issues with differentiation. This procedure can be used in meta-learning.

During each training step, a subset of the current batch Bᵢ is selected as the meta-training set [symbol] ₘₜᵣ. Meta-testing examples may be sampled with the largest distance from [symbol] ₘₜᵣ:

$${𝒟}_{mte} = {arg {max}_{top k}}_{{x}_{m} ∈ {B}_{i} \backslash {𝒟}_{mtr}} {max}_{{x}_{j} ∈ {𝒟}_{mtr}} {‖ {f}_{θ} ( {x}_{m} , 1 ) - {f}_{θ} ( {x}_{j} , 1 ) ‖}_{2}$$

where the distance is measured using an [symbol] ₂ norm between logits. The top k examples may be selected.

The meta-learning pass includes two steps: a meta-training step and a meta-testing step. To adapt the learner to the classification task, the gradients may be computed with respect to the ResNet blocks:

$${ℒ}_{{𝒟}_{m t r}} = \frac{1}{\vert {𝒟}_{mtr} \vert} {\sum }_{( x , y ) ∈ {𝒟}_{m t r}} ℒ ( {f}_{θ} ( x , 1 ) , y )$$

$${g}_{i}^{( 1 )} = \frac{\partial {ℒ}_{mtr} ( {f}_{θ} ( x , 1 ) , y )}{\partial {θ}_{b l o c {k}_{i}}}$$

The dropout mask can then be constructed as above to compute the meta-training loss and to update the learner weights:

$${ℒ}_{{𝒟}_{m t r}} = \frac{1}{\vert {𝒟}_{mtr} \vert} {\sum }_{( x , y ) ∈ {𝒟}_{m t r}} ℒ ( {f}_{θ} ( x , M ) , y )$$

$${θ}^{′} = θ - α ∘ {g}^{( 1 )}$$

The meta-test loss may be determined using the updated learner weight θ′:

$${ℒ}_{{𝒟}_{mte}} = \frac{1}{\vert {𝒟}_{mte} \vert} {\sum }_{( x , y ) ∈ {𝒟}_{mte}} ℒ ( {f}_{{θ}^{′}} ( x , g ) , y )$$

The meta-train and meta-test losses may then be combined with a γ-weighted average:

[symbol]

ᵢ−γ [symbol] +(1−γ)

[symbol]

where γ is a scalar parameter set by a user, while the parameters θ, learning rates α, and dropout ratios p are updated through the adaptation steps:

$$( θ , α , p ) ← ( θ , α , p ) - β {∇}_{θ , α , p} {\sum }_{i} {ℒ}_{i}$$

where β is a scalar parameter set by a user.

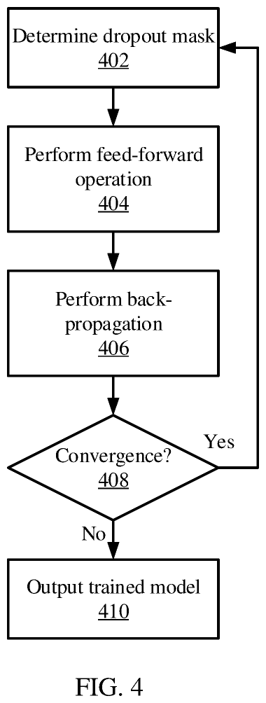

Referring now to FIG. 4, a method of training a neural network model is shown with GSNR-based dropout. Block 402 determines a dropout mask as described above, with particular activations of the neural network being set to zero. A feed-forward operation is performed 404 on the masked neural network, with masked neurons not contributing to the output of the model. Based on the output of the masked model following the feed-forward operation, back-propagation 406 may be performed to update the parameters of the neural network.

Performing training with dropout, as described here, helps to prevent overfitting. In some cases, training without dropout may result in parameters that work together to compensate for mistakes made elsewhere in the neural network. While such an arrangement can still produce good results within the training domain(s), it can provide poor performance in new domains. By masking some neurons, those interdependencies can be prevented and generalizability can be improved.

Block 408 determines whether the neural network parameters have converged, or whether some other stopping condition has been reached. If so, then block 410 outputs the final trained parameters of the neural network. If not, then processing returns to block 402 to determine a new dropout mask.

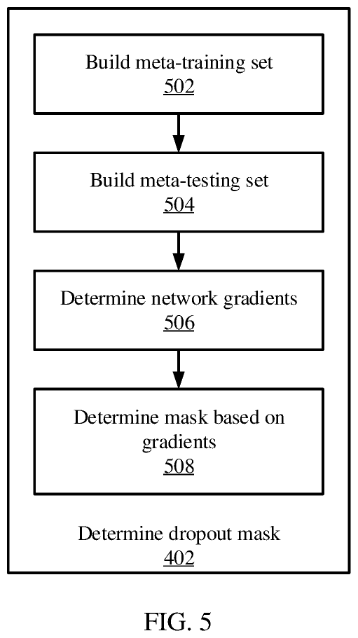

Referring now to FIG. 5, a method of determining a dropout mask based on GSNR 402 is shown. Block 502 builds a meta-training dataset from the batch Bᵢ and block 504 builds a meta-testing dataset with samples that have a large distance from those of the meta-training dataset.

Block 506 determines gradients for the different parts of the neural network, a process which may include the meta-training, meta-testing, and meta-optimization of FIG. 3. Based on these gradients, block 508 determines which parts of the neural network to mask. The selection of block 508 depends on a dropout ratio ρ that determines how many neurons will be dropped out and which may be determined along with the gradients in block 506.

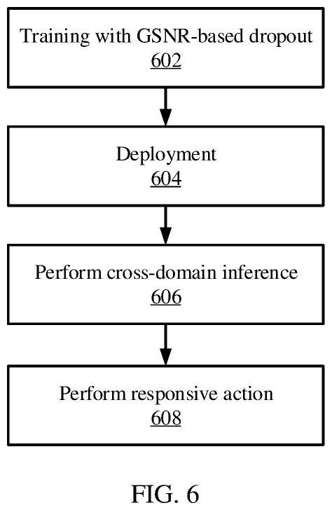

Referring now to FIG. 6, a method of training and using a neural network model across different domains is shown. Block 602 performs training of the neural network using GSNR-based dropout. As noted above, the training makes use of a dataset that includes one or more domains, such as images taken in particular lighting conditions or in particular geographic locations.

After the neural network model is trained, it may be deployed in block 604. For example, the trained neural network parameters may be copied to a vehicle's autonomous driving system or to a video security system. The target device then performs cross-domain inference 606, using the trained neural network in a domain that was not available during training. For example, in a pedestrian detection task on an autonomous vehicle that is trained with data in particular weather conditions, such as rainy, sunny, foggy, testing may be performed in an unseen weather condition such as snowy weather.

It is particularly contemplated that the cross-domain inference 606 may be employed using a visual task, such as object detection, person detection, facial recognition, object localization, and/or action recognition. This task may be part of a larger task, such as navigation for an autonomous vehicle or in a security system that monitors an environment.

Thus, an action may be performed responsive to the cross-domain inference. In the context of an autonomous vehicle, that action may include a navigational action, such as changing an acceleration or direction of the vehicle. In the context of a security system, the action may include a security action such as locking or unlocking a door or other access point, authorizing or denying access, and/or summing security personnel to investigate entry or suspicious activity by an unauthorized person.

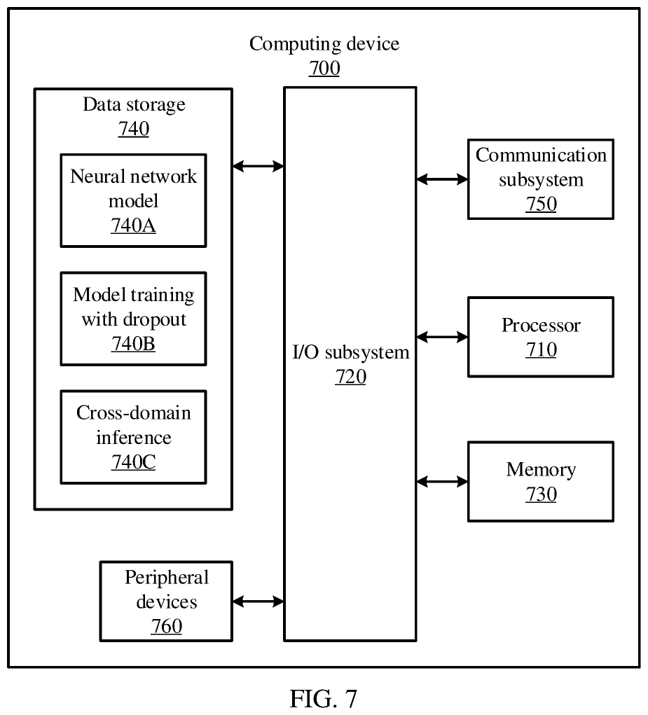

Referring now to FIG. 7, an exemplary computing device 700 is shown, in accordance with an embodiment of the present invention. The computing device 700 is configured to train a neural network model in a manner that is sensitive to GSNR.

The computing device 700 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 700 may be embodied as one or more compute sleds, memory sleds, or other racks, sleds, computing chassis, or other components of a physically disaggregated computing device.

As shown in FIG. 7, the computing device 700 illustratively includes the processor 710, an input/output subsystem 720, a memory 730, a data storage device 740, and a communication subsystem 750, and/or other components and devices commonly found in a server or similar computing device. The computing device 700 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 730, or portions thereof, may be incorporated in the processor 710 in some embodiments.

The processor 710 may be embodied as any type of processor capable of performing the functions described herein. The processor 710 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 730 may be embodied as any type of volatile or non-volatile memory or data storage capable of performing the functions described herein. In operation, the memory 730 may store various data and software used during operation of the computing device 700, such as operating systems, applications, programs, libraries, and drivers. The memory 730 is communicatively coupled to the processor 710 via the I/O subsystem 720, which may be embodied as circuitry and/or components to facilitate input/output operations with the processor 710, the memory 730, and other components of the computing device 700. For example, the I/O subsystem 720 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 720 may form a portion of a system-on-a-chip (SOC) and be incorporated, along with the processor 710, the memory 730, and other components of the computing device 700, on a single integrated circuit chip.

The data storage device 740 may be embodied as any type of device or devices configured for short-term or long-term storage of data such as, for example, memory devices and circuits, memory cards, hard disk drives, solid state drives, or other data storage devices. The data storage device 740 can store program code 740A for a neural network model, 740B for training the model with GSNR-based dropout, and/or 740C for cross-domain inference. Any or all of these program code blocks may be included in a given computing system. The communication subsystem 750 of the computing device 700 may be embodied as any network interface controller or other communication circuit, device, or collection thereof, capable of enabling communications between the computing device 700 and other remote devices over a network. The communication subsystem 750 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 700 may also include one or more peripheral devices 760. The peripheral devices 760 may include any number of additional input/output devices, interface devices, and/or other peripheral devices. For example, in some embodiments, the peripheral devices 760 may include a display, touch screen, graphics circuitry, keyboard, mouse, speaker system, microphone, network interface, and/or other input/output devices, interface devices, and/or peripheral devices.

Of course, the computing device 700 may also include other elements (not shown), as readily contemplated by one of skill in the art, as well as omit certain elements. For example, various other sensors, input devices, and/or output devices can be included in computing device 700, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 700 are readily contemplated by one of ordinary skill in the art given the teachings of the present invention provided herein.

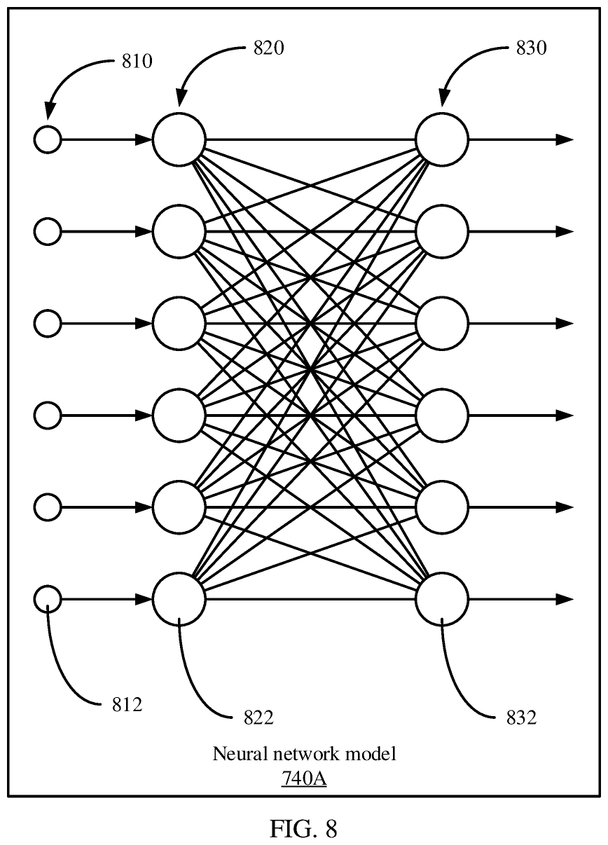

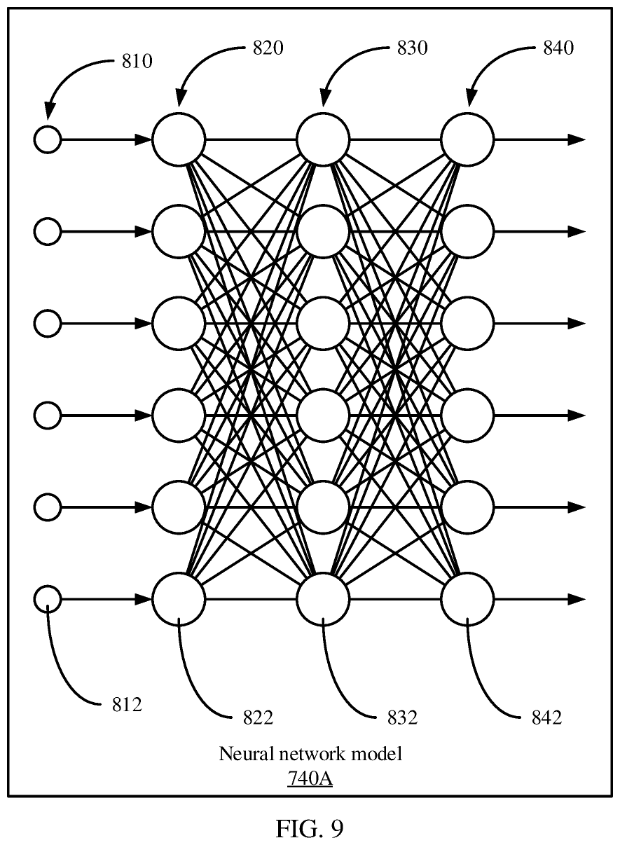

Referring now to FIGS. 8 and 9, exemplary neural network architectures are shown, which may be used to implement parts of the present models, such as the neural network model 740A. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 820 of source nodes 822, and a single computation layer 830 having one or more computation nodes 832 that also act as output nodes, where there is a single computation node 832 for each possible category into which the input example could be classified. An input layer 820 can have a number of source nodes 822 equal to the number of data values 812 in the input data 810. The data values 812 in the input data 810 can be represented as a column vector. Each computation node 832 in the computation layer 830 generates a linear combination of weighted values from the input data 810 fed into input nodes 820, and applies a non-linear activation function that is differentiable to the sum. The exemplary simple neural network can perform classification on linearly separable examples (e.g., patterns).

A deep neural network, such as a multilayer perceptron, can have an input layer 820 of source nodes 822, one or more computation layer(s) 830 having one or more computation nodes 832, and an output layer 840, where there is a single output node 842 for each possible category into which the input example could be classified. An input layer 820 can have a number of source nodes 822 equal to the number of data values 812 in the input data 810. The computation nodes 832 in the computation layer(s) 830 can also be referred to as hidden layers, because they are between the source nodes 822 and output node(s) 842 and are not directly observed. Each node 832, 842 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the inputted data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 832 in the one or more computation (hidden) layer(s) 830 perform a nonlinear transformation on the input data 812 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for training a model, comprising:
determining a dropout mask based on gradient signal to noise ratio (GSNR) of parameters of a neural network model;
training the neural network model with parameters zeroed-out according to the dropout mask; and
iteratively updating the dropout mask and performing the training based on the updated dropout mask.

2. The method of claim 1, wherein determining the dropout mask includes determining a dropout ratio that determines a number of parameters to zero-out.

3. The method of claim 2, wherein the dropout ratio varies for different parts of the neural network model.

4. The method of claim 1, wherein determining the dropout mask includes performing meta-training and meta-testing to update a loss function.

5. The method of claim 3, wherein determining the dropout mask includes determining a gradient of the loss function.

6. The method of claim 3, wherein performing meta-training and meta-testing includes selecting meta-training batch subset and a meta-testing batch subset, with examples of the meta-testing batch subset being selected according to their distance from the meta-training batch subset.

7. The method of claim 1, wherein training the neural network model includes a training dataset of examples in a first domain and wherein the dropout mask causes the training to better accommodate testing examples from second domains that are not included in the training dataset.

8. The method of claim 7, wherein the training dataset includes images and wherein the first domain and the second domains differ according to environmental conditions or geographic location.

9. The method of claim 1, wherein training the neural network model with parameters zeroed-out includes performing a feed-forward operation where parameters designated by the dropout mask are omitted.

10. The method of claim 1, wherein the GSNR of a parameter is determined as a ratio between the parameter's mean gradients with respect to a loss function and a corresponding variance.

11. A system for training a model, comprising:
a hardware processor; and
a memory that stores a computer program which, when executed by the hardware processor, causes the hardware processor to:
determine a dropout mask based on gradient signal to noise ratio (GSNR) of parameters of a neural network model;
train the neural network model with parameters zeroed-out according to the dropout mask; and
iteratively update the dropout mask and performing the training based on the updated dropout mask.

12. The system of claim 11, wherein the computer program further causes the hardware processor to determine a dropout ratio that determines a number of parameters to zero-out.

13. The system of claim 12, wherein the dropout ratio varies for different parts of the neural network model.

14. The system of claim 11, wherein the computer program further causes the hardware processor to perform meta-training and meta-testing to update a loss function to determine the dropout mask.

15. The system of claim 14, wherein the computer program further causes the hardware processor to determine a gradient of the loss function to determine the dropout mask.

16. The system of claim 14, wherein the computer program further causes the hardware processor to select a meta-training batch subset and a meta-testing batch subset, with examples of the meta-testing batch subset being selected according to their distance from the meta-training batch subset.

17. The system of claim 11, wherein the computer program further causes the hardware processor to use a training dataset of examples in a first domain and wherein the dropout mask causes the training to better accommodate testing examples from second domains that are not included in the training dataset.

18. The system of claim 17, wherein the training dataset includes images and wherein the first domain and the second domains differ according to environmental conditions or geographic location.

19. The system of claim 11, wherein the computer program further causes the hardware processor to perform a feed-forward operation where parameters designated by the dropout mask are omitted.

20. The system of claim 11, wherein the GSNR of a parameter is determined as a ratio between the parameter's mean gradients with respect to a loss function and a corresponding variance.
